(19) United States
(12) Patent Application Publication
(10) Pub. No.: US 2026/0167116 A1
(43) Pub. Date: Jun. 18, 2026

(54) Movable Apparatus for Track Structure Disease Recognition

(71) Applicant: BEIJING JIAOTONG UNIVERSITY, Beijing (CN)

(72) Inventors: Bowen HOU, Beijing (CN); Lang WANG, Beijing (CN); Liang GAO, Beijing (CN); Hui YIN, Beijing (CN); Kaiyue HU, Beijing (CN); Xiaopei CAI, Beijing (CN); Yunwei ZHU, Beijing (CN); Jiangbin LI, Beijing (CN)

(73) Assignee: BEIJING JIAOTONG UNIVERSITY, Beijing (CN)

(21) Appl. No.: 18/709,808

(22) PCT Filed: Feb. 2, 2024
(86) PCT No.: PCT/CN2024/075369

§ 371 Date: May 14, 2024

(30) Foreign Application Priority Data
Jan. 2, 2024 (CN) 202410009196.4

(51) Int. Cl. B60R 9/10; B60N 2/50; B62D 55/10; B62D 55/20; B62D 55/24

(52) U.S. Cl. CPC B60R 9/10; B60N 2/502; B62D 55/10; B62D 55/202; B62D 55/244

(57) ABSTRACT

A movable apparatus for track structure disease recognition is provided. The movable apparatus includes a supporting frame, further includes a loading assembly, a travelling assembly, and a control system that are connected to the supporting frame, as well as a data collection system configured to collect response information fed back from a recognized track. The loading assembly includes a knocking wheel configured to roll on a top surface of the recognized track, and a hammering mechanism configured to apply an excitation load downwards to the knocking wheel. The travelling assembly includes travelling wheels located at a front end and a rear end of the knocking wheel. The control system includes a mileage monitoring module configured to monitor distance travelled by any of the travelling wheels, and a control module configured to drive the hammering mechanism to operate. The mileage monitoring module is connected with the control module through signals.

### TECHNICAL FIELD

The present disclosure relates to the technical field of track detection, and in particular, to a movable apparatus for track structure disease recognition.

### BACKGROUND

Under reciprocating action of train loads, various types of diseases are prone to occur in track structures. Demands for maintenance and repair of track lines and track detection continuously increase. Existing track detection includes on-site manual inspection, detection based on laser technology or image processing technology, pulse excitation-based disease recognition and detection, and the like. In pulse excitation-based disease recognition technology, vibration and noise signals under an action of external excitation loads on a track are collected, and track diseases are recognized according to differences in response. The technology can accurately and timely detect and evaluate track diseases, find poor condition problems early, identify hidden dangers in the track structure, and is conductive to reducing safety hazards of sudden brittle fracture of railway lines during service, thereby guaranteeing normal and orderly operation of track transit.

To improve online detection capability of railway tracks, the applicant of the present application has carried out a series of research and development in advance, such as:

CN112379004A discloses a movable loading apparatus for track disease recognition. In the apparatus, a loading mechanism can be controlled to knock a steel track and apply excitation to achieve signal excitation, while the movable loading apparatus is controlled to travel, and then data, such as vibration acceleration, sound pressure, loading frequency, and loading force amplitude, is collected, and track diseases are determined according to differences in response. However, the apparatus has the following technical defects: stability is poor when a loading force is great; a loading landing point cannot be controlled accurately during travelling; rotating force arm of a multi-head hammering is small, and a loading force magnitude is difficult to be adjusted; and impact signals produced by multiple hammer heads interfere with each other, and the resulting impact noise signals also interfere with each other.

CN113834744A discloses a pulse excitation loading mechanism for a track structure. The mechanism performs segment processing on an assembled loading wheel, and the entire apparatus is driven by a rotary motor to move forward along a testing track. The assembled loading wheel rotates one revolution, a compression leg hits the steel track once, so that loading of pulse excitation is achieved. However, the apparatus has the following technical defects: a hammering position can only be controlled by adjusting wheel diameter of the assembled loading wheel after being subjected to the segment processing, and position of a landing point cannot be controlled accurately, and pulse excitation cannot be ensured to be accurately loaded between tracks. A loading method is that a disc wheel is cut to impact the track and produce hammering excitation, the wheel needs to overcome great resistance during operation, and the stability is poor during detection work, so the apparatus is not suitable for long-time and long-distance detection.

In addition, there are technologies in which wheel-load-drop excitation directly impacts the steel track and hammering excitation is applied to position of an axle in the prior art. However, such technologies are only suitable for vibration reduction evaluation of track systems at present, and are difficult to apply to recognition and positioning of track diseases. Moreover, such technologies need to be retrofitted on a running train, and are greatly affected by service state of the train.

### SUMMARY

The present disclosure provides a movable apparatus for track structure disease recognition to solve the problems in the prior art that a loading landing point is difficult to be controlled accurately, loading stability is poor, and a loading force magnitude is difficult to be adjusted when online detection is performed on a railway track, and achieves purposes of improving control accuracy of the loading landing point, realizing accurate adjustment of the loading force by calculating changes in rigidity of a spring and mass of a hammer head, and improving loading stability.

The present disclosure is realized through the following technical solutions.

A movable apparatus for track structure disease recognition includes a supporting frame, and further includes a loading assembly, a travelling assembly, and a control system that are connected to the supporting frame, as well as a data collection system configured to collect response information fed back from a recognized track.

The loading assembly includes a knocking wheel configured to roll on a top surface of the recognized track, and a hammering mechanism configured to apply an excitation load downwards to the knocking wheel.

The travelling assembly includes travelling wheels located at a front end and a rear end of the knocking wheel. The travelling wheels are configured to roll on the top surface of the recognized track. Sensors may also be arranged at the travelling wheels to recognize vibration conditions of vibration produced at an excitation point and transmitted along the steel track to axles of a front wheel and a rear wheel.

The control system includes a mileage monitoring module configured to monitor distance travelled by any of the travelling wheels, and a control module configured to drive the hammering mechanism to operate. The mileage monitoring module is connected with the control module through signals.

For the problems in the prior art that a loading landing point is difficult to be controlled accurately, and loading stability is poor when online detection is performed on a railway track, the present disclosure provides a movable apparatus for track structure disease recognition. In the apparatus, a supporting frame is used as a main body frame of the entire movable apparatus. The loading assembly, the travelling assembly, the control system, and the data collection system are arranged on the supporting frame. The loading assembly is in contact with a top of the recognized track through the knocking wheel. The hammering mechanism applies an excitation load to the knocking wheel. The excitation load is transmitted to an underneath track through the knocking wheel. Meanwhile, the knocking wheel may roll along with movement of the movable apparatus. The entire movable apparatus moves along the railway track through the travelling assembly. In the travelling assembly, at least one travelling wheel is arranged at each of a front end and a rear end of the knocking wheel. The travelling wheels also roll on the top surface of the recognized track. The front end and the rear end of the knocking wheel refer to a forward direction and a backward direction of the movable apparatus in an extension direction of the track. The control system of the present application includes the mileage monitoring module and the control module. The mileage monitoring module monitors the distance travelled by any of the travelling wheels, so as to determine the movement distance of the entire movable apparatus on the track. The control module control, according to the movement distance, the hammering mechanism to operate.

According to the present application, during operation, a hammering distance spacing is preset in the control module in advance, and the movable apparatus is pushed to move forward on the recognized track by human or other external forces, for example, the movable apparatus may be suspended behind a running train or towed on a railway line by means of a road-railer. The mileage monitoring module monitors the travelling distance in real time. When the movable apparatus moves forward by a preset distance spacing, the control module drives the hammering mechanism to operate once, impact load excitation is applied to the track once, and required data signals are collected through the data collection system, so as to determine and recognize whether there are corresponding diseases in a current track segment on this basis. Therefore, according to the present application, track diseases can be recognized through differences in response by collecting related response signals of the track under the action of an external excitation load and combining them with an existing data analysis program, the track diseases can be evaluated timely and accurately, hidden dangers in the track structure and poor condition problems in lines can be found as early as possible, and problems of inconsistent manual detection standards and high environmental requirements relying on manual experience, laser technology, and image processing technology can be solved. Recognition and classification of different diseases of the track structure can be realized.

According to the present application, compared with the prior art: (1) accurate loading at a specified position can be automatically implemented during travelling, a loading position can be ensured to be a position that needs to be recognized; for different track spacing, a position of a landing point of the loading assembly can be accurately controlled; taking recognizing track diseases as an example, each subsequent loading can be ensured to be directly above or near the track by just ensuring that an initial loading position is directly above a certain track and presetting a track spacing in the control module in advance, so that the collected information can reflect state of the track more accurately; (2) the apparatus is pushed to travel by external forces, power sources such as a motor for travelling do not need to be arranged inside the apparatus, vibration and noise interference of the power sources such as the motor inside the apparatus can be reduced, and the recognition accuracy can be improved; moreover, interference caused by non-uniform pushing speed when the apparatus is pushed to move forward by the external forces can be avoided while the accuracy of the loading landing point is ensured through the cooperation of the mileage monitoring module and the control module, and the accuracy of the loading position can also be ensured even if a worker pushes the apparatus to move forward at varying speeds, which significantly improves the operability of online detection and recognition of railway tracks; (3) the loading assembly includes and only includes the knocking wheel, so there is no mutual interference between impact signals and impact noise of the track, and the stability of disease recognition when a loading force is great is improved; and (4) the knocking wheel is used for directly loading to the track from a top, and the knocking wheel can assist the apparatus in moving on the top of the track, which can significantly reduce the running resistance on the track, compared with a cutting disc loading manner in the prior art, so that the apparatus runs more stably, thereby facilitating a long-time and long-distance detection and recognition work.

Further, the hammering mechanism includes a mounting plate fixed to the supporting frame, a knocked shaft penetrating through the mounting plate, a force transmission wheel connected below the knocked shaft, a knocking hammer located above the knocked shaft, and a power mechanism configured to drive the knocking hammer to knock a top end of the knocked shaft. The power mechanism is connected to the mounting plate. The force transmission wheel is in contact with a top end of the knocking wheel.

In the solution, when the hammering mechanism is driven to operate by the control module, the knocking hammer is driven by the power mechanism, so that the knocking hammer knocks the top end of the knocked shaft, and then excitation is transmitted to the force transmission wheel and the knocking wheel in sequence, thereby achieving loading of pulse excitation on the underneath track. The force transmission wheel and the knocking wheel are in contact with each other, that is, capable of rotating relative to each other, thereby ensuring normal rolling of the knocking wheel at the top of the track while ensuring effective transmission of an excitation load, and avoiding interference of the force transmission wheel with the normal rolling and travelling of the knocking wheel. In addition, excitation is applied in a manner of knocking by the knocking hammer, which can ensure low background noise and reduce interference with the response information fed back from the track.

Further, the movable apparatus further includes a lower wheel seat configured to mount the knocking wheel, and a mounting seat fixedly connected to both the knocked shaft and the lower wheel seat. The mounting seat is suspended below the mounting plate through several connecting pieces. A suspension height of the mounting seat is adjustable.

In the prior art, impact excitation is easily transmitted to an online detection apparatus body synchronously when being transmitted to the underneath track, which leads to high background noise and mutual interference among various sensors, seriously affecting the accuracy of detection and recognition. In the present solution, the mounting seat is suspended below the mounting plate through several connecting pieces, so that the lower wheel seat, the knocking wheel, the knocked shaft, and the mounting seat are suspended together. This connecting manner has good vibration isolation effect, and can significantly reduce the transmission of impact excitation to the supporting frame body, thereby effectively overcoming the problems of high background noise and mutual interference among various sensors in the data collection system.

In addition, the suspension height of the mounting seat in the present solution is adjustable, that is, the height of the knocking wheel is adjustable. A pre-pressure is applied to the mounting seat through an upper spring, so as to ensure that the knocking wheel is closely attached to the steel track constantly through a series of continuous contact among the mounting seat, a hammered part of a hammer head, the force transmission rod, the knocking wheel, and the like, thereby improving the applicability of the present application to tracks of different heights. There is no limitation to a specific adjustment manner for the suspension height of the mounting seat here. Any height adjustment manner that can be achieved by those skilled in the art is applicable, for example, adjusting a length of each connecting piece, adjusting a length of the knocked shaft, and even adjusting a longitudinal height of the lower wheel seat as required. In addition, the mounting seat may be fixedly connected to the knocked shaft and the lower wheel seat in any manner, preferably, in a detachable fixed connection.

Further, the movable apparatus further includes an upper wheel seat configured to mount the force transmission wheel, and a first elastic piece sleeved outside the knocked shaft. The upper wheel seat is connected to a bottom end of the knocked shaft. The first elastic piece is located between the upper wheel seat and the mounting seat.

In the present solution, a downward thrust is always provided for the upper wheel seat through a pre-load of the first elastic piece, and then the force transmission wheel and the knocking wheel are always subjected to a downward thrust, so as to ensure that the knocking wheel is always tightly attached to the top of the recognized track, and ensure that the excitation load can be effectively transmitted to the underneath track. A top end of the first elastic piece is positioned through the mounting seat.

Further, the power mechanism includes a cam, a motor configured to drive the cam to rotate, a rotating rod movably pressed against the cam, and a fixing rod in rotating fit with the rotating rod. The knocking hammer is mounted on the rotating rod. The fixing rod is fixedly connected to the mounting plate. The motor is connected with the control module through signals.

According to the present solution, in a normal state, the rotating rod is lifted by the cam, so that the knocking hammer is not in contact with the knocked shaft. When the hammering mechanism is driven to operate by the control module, the motor is started to drive the cam to rotate, so that the rotating rod is rotated downwards around the fixing rod to drive the knocking hammer on the rotating rod to rotate downwards until the knocking hammer knocks the top end of the knocked shaft. According to the present solution, the magnitude of hammering excitation is adjusted by replacing hammers with different masses and first elastic pieces with different rigidities, and a length of a force arm may also be adjusted by changing the shape of the cam to control the magnitude of the hammering excitation. The stability of the amplitude and pulse characteristics of the loading force can be ensured, and the stability of the performance of the loading mechanism can be ensured, so that the structure is light-weight, and on-site adjustment and operation are facilitated.

When the hammering mechanism is driven to operate once by the control module, an output end of the motor is rotated by 360°, that is, the cam is driven to rotate one revolution.

Further, the movable apparatus further includes a second elastic piece, and a positioning piece located below the mounting plate. Two ends of the second elastic piece are respectively detachably connected to the rotating rod and the positioning piece.

In the prior art, a load is completely provided by the gravity of the loading assembly. The loading assembly needs to have a great dead weight if a great excitation load needs to be obtained. This will undoubtedly increase the entire mass and volume of the apparatus, and indirectly leads to more stringent structural complexity and material requirements. And, in the prior art, the stability of performance will be affected when the loading force is great, and even the accuracy of a loading position will be interfered. To overcome the above problems, the second elastic piece is arranged specifically in the present solution. A top end of the second elastic piece is connected to the rotating rod, and a bottom end is connected to the positioning piece, so a downward pulling force can always be provided for the rotating rod through a pre-load of the second elastic piece. When the cam rotates to release a limitation on the rotating rod, the pulling force can be released instantaneously, and then greater momentum is provided for the rotating rod and the knocking hammer, thereby achieving an effect of obtaining a great excitation load without increasing the dead weight of the apparatus.

In addition, both ends of the second elastic piece are detachably connected in the present solution. Therefore, pre-loads of different magnitudes can be provided by replacing second elastic pieces with different rigidities, which significantly improves the flexibility of use and expands the scope of application of the present application. Moreover, when the pre-load of the second elastic piece is great enough, the hammering load in the present solution is mainly provided by the second elastic piece, and gravity only plays an auxiliary role. Under this working condition, the stability of the structure and performance of the loading assembly can be ensured better, which ensures good stability of the amplitude and pulse characteristics of the loading force during long-distance and long-time operation.

In the present solution, the positioning piece is located below the mounting plate, it is only necessary to ensure that the positioning piece is fixed to the mounting plate, and the second elastic piece always provides the downward pulling force for the rotating rod. There is not limitation on specific connecting positions, for example, the positioning piece may be connected to a bottom of the mounting plate, connected to the mounting seat, or even connected to the lower wheel seat.

Further, the movable apparatus further includes a triggering plate that is coaxially and fixedly connected to the cam, and a sensing device that matches the triggering plate. The sensing device is configured to sense a rotating direction of the triggering plate. The sensing device is connected to the control module through signals.

In the present application, although the travelling distance is monitored by the mileage monitoring module and the hammering mechanism is controlled to operate, this cannot ensure that the cam is at an initial position at the beginning of each operation and can return to an ideal initial state of lifting the rotating rod to a highest position after each rotation. Once an initial position error of the cam is large or the reset is unstable, it is not conducive to ensuring the stability of the amplitude and pulse characteristics of the loading force. To overcome this problem, the triggering plate and the sensing device are further arranged in the present solution. The triggering plate can coaxially rotate with a rotation shaft of the cam. A rotation direction of the triggering plate is recognized by the sensing device, and then a current orientation of the cam can be determined.

According to the present application, at the beginning of each operation and after each hammering by the hammering mechanism, the rotation direction of the triggering plate is recognized by the sensing device, and a recognition result is transmitted to the control module. Whether the cam is currently reset to an initial state is determined by the control module. If any deviation is found in the orientation of the cam, the motor can be controlled to start by the control module, and then the orientation of the cam can be modified in real time during movement of the present application, which further ensures the stability of the amplitude and pulse characteristics of the loading force during long-distance and long-term operation.

There is no limitation on specific shapes of the triggering plate, and specific recognition manners of a current rotation direction of the triggering plate by the sensing device. Any sensing technology that can determine the required direction is applicable to the present application, for example, achieving sensing through photoelectric manners such as infrared ray or laser, or achieving sensing through mechanical manners such as a pressure or a magnetic force.

Further, the travelling assembly further includes several auxiliary wheels that are located at a bottom of the supporting frame and are inwards distributed in pairs, and several universal wheels located below the supporting frame. The auxiliary wheels are configured for maintaining structural stability.

The auxiliary wheels in the present solution face each other in pairs, and are distributed inwards at the bottom of the supporting frame. In the present application, during operation, the auxiliary wheels on both sides are respectively in contact with two side surfaces of the recognized track, which significantly improves the stability of the apparatus during movement, and is more conductive to completing a long-time and long-distance detection recognition operation. In addition, transferring is facilitated by universal wheels during transferring the movable apparatus of the present application.

Further, the control system further includes a human-computer interaction module connected to the control module through signals. According to the present solution, information interaction between a worker and the control module can be realized through the human-computer interaction module, for example, setting a required loading spacing, observing working conditions of the control system and the data collection system, and reading collected data information in real time. Existing human-computer interaction technologies such as a control button/key, a display, a signal indicator lamp, a touch screen device, and even an APP that matches a smart phone are applicable.

Further, the data collection system includes a first sensor configured to monitor a hammering force of the hammering mechanism, a second sensor configured to monitor wheel-track noise of the knocking wheel and the recognized track, a third sensor configured to monitor a vibration acceleration of the knocking wheel, a fourth sensor configured to monitor a vibration acceleration of the supporting frame, a fifth sensor configured to monitor a vibration acceleration of a front wheel, a sixth sensor configured to monitor a vibration acceleration of a rear wheel, and a data collection module configured to store collected response information.

There is no limitation on specific mounting positions and product models of the sensors. Those skilled in the art can select and mount the sensors adaptively according to actual working conditions. In addition, the data collection module may locally store response information collected by the data collection system, so as to facilitate exporting data to a local computer for subsequent off-line analysis after the current operation is completed, and on-line data analysis and disease warning can also be realized. Of course, the data collection module can also transmit the collected data online to a background computer or a cloud in real time in a wireless transmission manner.

Compared with the prior art, the present disclosure achieves the following advantages and beneficial effects:
1. According to the present disclosure, accurate loading at a specified position can be automatically realized during travelling, and a hammering landing point can be accurately controlled according to different track spacing, so that the collected information can more accurately reflect states of track diseases.
2. According to the present disclosure, the movable apparatus is pushed to travel by external forces, and power sources such as a motor for travelling does not need to be arranged inside the apparatus, so that the vibration and noise interference of the power sources such as the motor inside the apparatus can be reduced, thereby improving recognition accuracy. The interference caused by instable pushing speed when the movable apparatus is pushed to move forward by the external forces is avoided while the accuracy of the loading landing point is ensured, the accuracy of the loading position is ensured, and the operability of online detection and recognition of railway tracks is significantly improved.
3. According to the present disclosure, the knocking wheel is used as a direct loading component, there is no mutual interference between impact signals and impact noise of the track, and the stability of disease recognition when the loading force is great is improved.
4. According to the present disclosure, the knocking wheel can assist the entire apparatus in moving at the top of the track. Compared with a cutting disc loading manner in the prior art, running resistance on the track can be significantly reduced, so that the apparatus runs more stably, thereby facilitating long-time and long-distance detection and recognition work.
5. According to the present disclosure, the mounting seat is suspended below the mounting plate through several connecting pieces, so that the lower wheel seat, the knocking wheel, the knocked shaft, and the mounting seat are suspended together. A good vibration isolation effect is achieved through suspending, which can significantly reduce the transmission of the impact excitation to the supporting frame body, thereby effectively overcoming the problems of high background noise and mutual interference among various sensors in the data collection system.
6. According to the present disclosure, the magnitude of hammering excitation can be adjusted by replacing hammers with different masses, or a length of a force arm may also be adjusted by changing the shape of the cam to control the magnitude of the hammering excitation. The stability of the amplitude and pulse characteristics of the loading force can be improved, and the stability of the performance of the loading mechanism can be ensured, so that the structure is light-weight, and on-site adjustment and operation are facilitated.
7. According to the present disclosure, an effect of obtaining a great excitation load is achieved without increasing the dead weight of the apparatus. Pre-loads of different magnitudes are provided by replacing second elastic pieces with different rigidities, which can significantly improve the flexibility of use and expand the scope of application of the present application. Meanwhile, the stability of structure and performance of the loading assembly is further ensured through the second elastic piece, and good stability of the amplitude and pulse characteristics of the loading force is ensured during long-distance and long-time operation.
8. According to the present disclosure, the movable apparatus has the characteristics of smooth operation and low travelling resistance, which is conductive to reducing labor consumption and facilitating long-time and long-distance track disease recognition operations.

### BRIEF DESCRIPTION OF THE DRAWINGS

Accompanying drawings described here are used to provide a further understanding of embodiments of the present disclosure, and constitute a part of the present application, but do not constitute a limitation on the embodiments of the present disclosure. In the drawings:

FIG. 1 is a structural schematic diagram of a movable apparatus in a specific embodiment of the present disclosure in a working condition;

FIG. 2 is a structural schematic diagram of an interior of a movable apparatus in a specific embodiment of the present disclosure;

FIG. 3 is a structural schematic diagram of a loading assembly in a specific embodiment of the present disclosure;

FIG. 4 is a partial front view of a loading assembly in a specific embodiment of the present disclosure;

FIG. 5 is a partial side view of a loading assembly in a specific embodiment of the present disclosure; and

FIG. 6 is a partial structural schematic diagram of a loading assembly in a specific embodiment of the present disclosure.

Reference signs in the drawings and corresponding component names:

101 storage battery, 201 first sensor, 202 human-computer interaction module, 301 connecting piece, 302 knocking hammer, 303 knocked shaft, 304 motor, 305 triggering plate, 306 sensing device, 307 cam, 308 mounting plate, 309 mounting seat, 310 lower wheel seat, 311 first elastic piece, 312 upper wheel seat, 313 force transmitting wheel, 314 knocking wheel, 315 rotating rod, 316 fixing rod, 317 second elastic piece, 318 positioning piece, 401 data collection module, 402 control module, 403 mileage monitoring module, 501 travelling wheel, 502 auxiliary wheel, and 503 universal wheel.

### DETAILED DESCRIPTION OF THE EMBODIMENTS

To make the purposes, technical solutions, and advantages of the present disclosure clearer, the present disclosure is further described in detail below with reference to the embodiments and drawings. Illustrative implementations of the present disclosure and explanations thereof are only intended to explain the present disclosure and do not limit the present disclosure. In the descriptions of the present disclosure, it is to be noted that orientations or positional relationships indicated by terms “front”, “rear”, “left”, “right”, “upper”, “lower”, “vertical”, “horizontal”, “high”, “low”, “inner”, “outer”, and the like are the orientations or positional relationships shown based on the drawings, and are only for the convenience of describing the present disclosure and simplifying the description, rather than indicating or implying that the apparatuses or elements must have particular orientations, and constructed and operated in particular orientations. Thus it cannot be construed as a limitation to the present disclosure.

### Embodiment 1

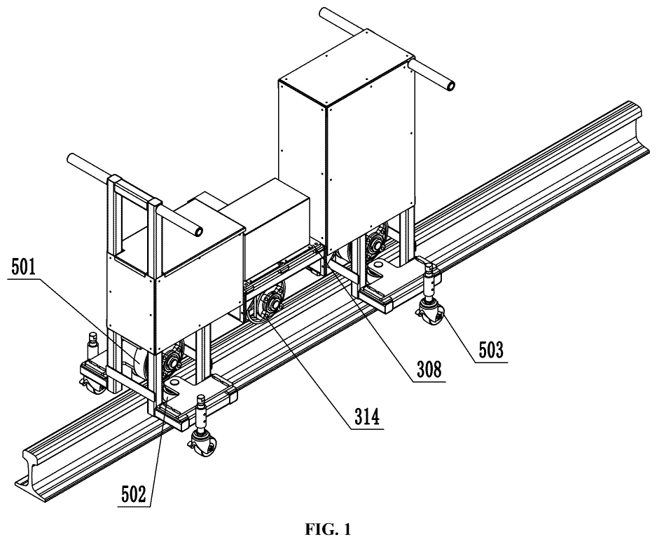

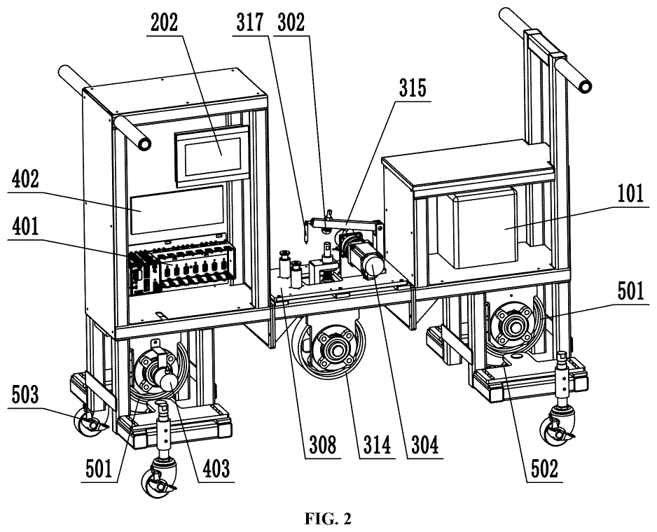

As shown in FIG. 1 and FIG. 2, a movable apparatus for track structure disease recognition includes a supporting frame, a loading assembly, a travelling assembly, and a control system that are connected to the supporting frame, as well as a data collection system configured to collect response information fed back from a recognized track.

The loading assembly includes a knocking wheel 314 configured to roll on a top surface of the recognized track, and a hammering mechanism configured to apply an excitation load downwards to the knocking wheel 314.

The travelling assembly includes travelling wheels 501 located at a front end and a rear end of the knocking wheel 314. The travelling wheels 501 are configured to roll on the top surface of the recognized track.

The control system includes a mileage monitoring module 403 configured to monitor distance travelled by any of the travelling wheels 501, and a control module 402 configured to drive the hammering mechanism to operate. The mileage monitoring module 403 is connected with the control module 402 through signals.

Preferably, there are two travelling wheels 501 in total, which are respectively located on a front side and a rear side of the knocking wheel 314. The travelling wheels 501 use rubber coated wheels for reducing the interference of vibration and noise with the knocking wheel 314 in a travelling process of the movable apparatus.

Preferably, the mileage monitoring module 403 uses a programmer, and the control module 402 uses a Programmable Logic Controller (PLC).

As shown in FIG. 1, the loading assembly, the control system, the data collection system, and the like in the present embodiment are all located inside respective housings. FIG. 2 shows a state after hiding each housing. The movable apparatus of the present embodiment is provided with a storage battery 101 for supply power to all electrical devices in the movable apparatus. Preferably, a control switch configured to control whether the storage battery 101 supplies power or not is also arranged. When the present embodiment needs to be used for recognizing a track disease, the control switch is turned on manually.

In a more preferred implementation, the travelling assembly further includes several auxiliary wheels 502 that are located at a bottom of the supporting frame and are inwards distributed in pairs, and several universal wheels 503 located below the supporting frame. The auxiliary wheels 502 are configured to maintain structural stability.

In a more preferred implementation, the universal wheels 503 may be connected through telescopic rods. When the universal wheels 503 do not need to be used, for example, the track is detected, the universal wheels 503 may be withdrawn through the telescopic rods to separate from the ground on both sides of the track to reduce the interference with track disease recognition.

In a more preferred implementation, the control system further includes a human-computer interaction module 202 connected to the control module through signals. Preferably, the human-computer interaction module 202 is a touch screen mounted on a surface of the supporting frame.

### Embodiment 2

A movable apparatus for track structure disease recognition, on the basis of Embodiment 1, the hammering mechanism as shown in FIG. 2 to FIG. 6 includes a mounting plate 308 fixed to the supporting frame, a knocked shaft 303 penetrating through the mounting plate 308, a force transmission wheel 313 connected below the knocked shaft 303, a knocking hammer 302 located above the knocked shaft 303, and a power mechanism configured to drive the knocking hammer 302 to knock a top end of the knocked shaft 303. The power mechanism is connected to the mounting plate 308. The force transmission wheel 313 is in contact with a top end of the knocking wheel 314.

The hammering mechanism further includes a lower wheel seat 310 configured to mount the knocking wheel 314, and a mounting seat 309 fixedly connected to both the knocked shaft 303 and the lower wheel seat 310. The mounting seat 309 is suspended below the mounting plate 308 through several connecting pieces 301. A suspension height of the mounting seat 309 is adjustable.

In the present embodiment, a wheel diameter of the force transmission wheel 313 is far less than a wheel diameter of the knocking wheel 314. The connecting pieces 301 use linear bearings. The suspension height of the mounting seat 309 may be adjusted by adjusting the length of each linear bearing. A hole for the mounting seat 309 and the knocked shaft 303 to penetrate is formed in the mounting plate 308. The mounting seat 309 in the present embodiment is of a Z-shaped structure, an upper end thereof is located above the mounting plate 309 and is fixedly sleeved on the knocked shaft 303, and a lower end is fixedly connected to a top end of the lower wheel seat 310.

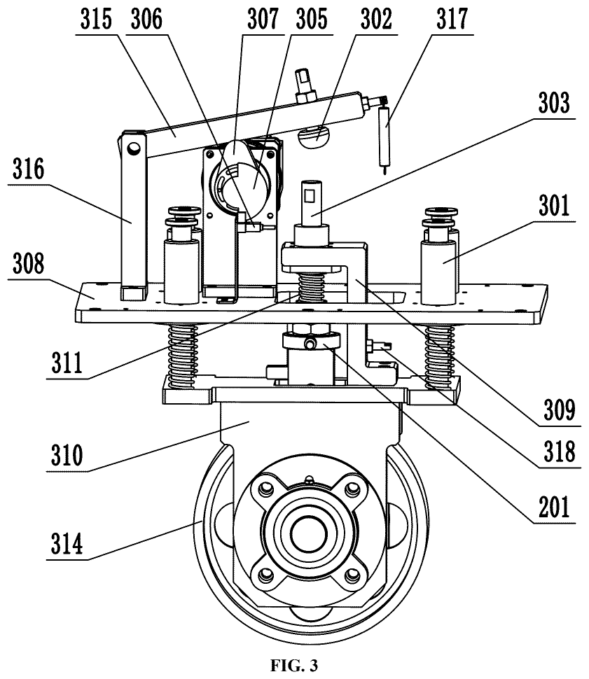

Preferably, as shown in FIG. 3, a thrust spring may also be sleeved over the linear bearing. Two ends of the thrust spring are respectively pressed against a bottom surface of the mounting plate 308 and a top surface of the lower wheel seat 310, so as to provide a more powerful jacking force for the knocking wheel 314 to ensure that the knocking wheel 314 is closely attached to the recognized track.

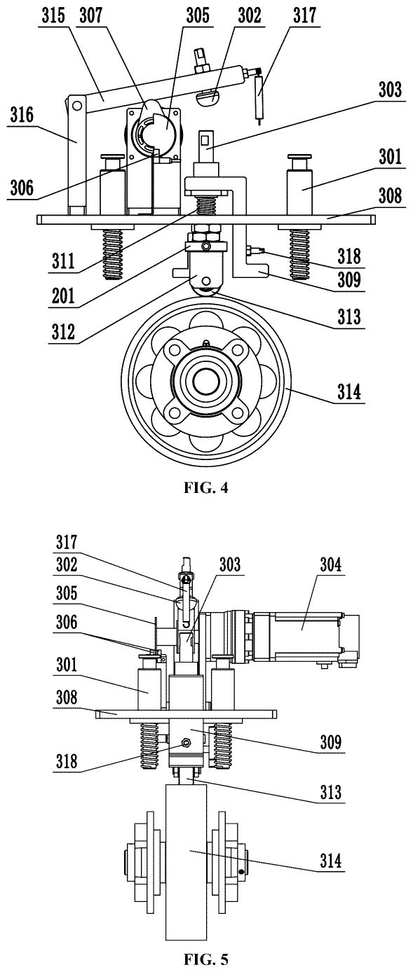

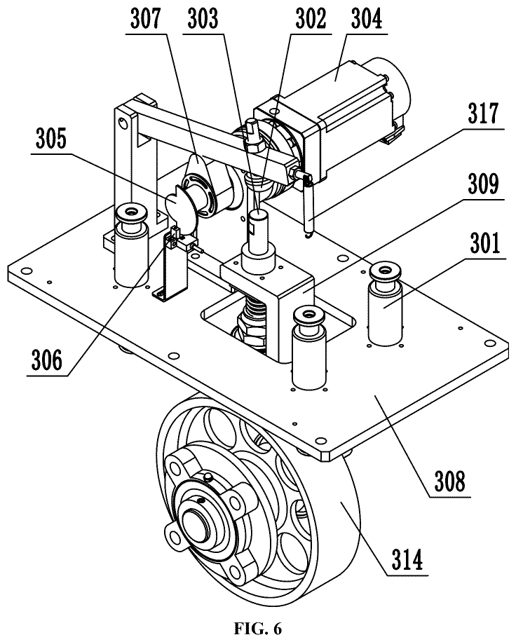

It is to be noted that, in FIG. 4, FIG. 5, and FIG. 6, to facilitate showing an internal structure of the hammering mechanism, the lower wheel seat 310 is hidden.

The hammering mechanism of the present embodiment further includes an upper wheel seat 312 configured to mount the force transmission wheel 313, and a first elastic piece 311 sleeved outside the knocked shaft 303. The upper wheel seat 312 is connected to a bottom end of the knocked shaft 303. The first elastic piece 311 is located between the upper wheel seat 312 and the mounting seat 309. The first elastic piece 311 uses a thrust spring that is in a compressed state all the time.

In the present embodiment, the power mechanism includes a cam 307, a motor 304 configured to drive the cam 307 to rotate, a rotating rod 315 movably pressed against the cam 307, and a fixing rod 316 in rotating fit with the rotating rod 315. The knocking hammer 302 is mounted on the rotating rod 315. The fixing rod 316 is fixedly connected to the mounting plate 308. The motor 304 is connected with the control module through signals. The motor 304 uses a servo motor to improve the control accuracy, for example, a servo motor with a model of hg-kn43j-s100.

The power mechanism further includes a second elastic piece 317, and a positioning piece 318 located below the mounting plate 308. Two ends of the second elastic piece 317 are respectively detachably connected to the rotating rod 315 and the positioning piece 318.

In the present embodiment, the positioning piece 318 is fixed to the mounting seat 309. The second elastic piece 317 is a tension spring. Hanging hooks are arranged at both ends of the second elastic piece 317. Hanging holes that match the foregoing hanging hooks are formed in the positioning piece 318 and an end of the rotating rod 315, which facilitating selecting the second elastic piece 317 with a proper rigidity according to actual operation conditions and completing mounting quickly by a worker.

In a preferred implementation, the movable apparatus further includes a triggering plate 305 that is coaxially and fixedly connected to the cam 307, and a sensing device 306 that matches the triggering plate 305. The sensing device 306 is configured to sense a rotating direction of the triggering plate 305. The sensing device 306 is connected to the control module 402 through signals.

Preferably, the triggering plate 305 is formed by a small-diameter semicircular plate and a large-diameter semicircular plate that are coaxial with each other. The sensing device 306 uses a slot switch, for example, a slot switch with a model of ee-sx671-wr306. The triggering plate 305 is located between correlation structures of the slot switch. The distance between the slot switch and a rotation shaft of the triggering plate 305 is greater than a radius of the small-diameter semicircular plate and is less than a radius of the large-diameter semicircular plate. Through such arrangement, when the large-diameter semicircular plate rotates to the slot switch, the slot switch can sense the triggering plate. When the small-diameter semicircular plate rotates to the slot switch, the slot switch cannot sense the triggering plate. A protrusion of the cam 307 is set to be upward when a junction of the small-diameter semicircular plate and the large-diameter semicircular plate is rotated to the slot switch, and the protrusion of the cam 307 is set to be downward when another junction of the small-diameter semicircular plate and the large-diameter semicircular plate is rotated to the slot switch. Through such arrangement, the rotation direction of the triggering plate 305 can be determined through sudden changes of sensing signals of the slot switch, then the cam 307 can stably return to an original position after each hammering, and the knocked shaft 303 can be knocked downward from a highest point each time, thereby ensuring the stability of an excitation force.

### Embodiment 3

A movable apparatus for track structure disease recognition, on the basis of Embodiment 1 or 2, the data collection system includes a first sensor 201 configured to monitor a hammering force of the hammering mechanism, a second sensor configured to monitor wheel-track noise of the knocking wheel 314 and the recognized track, a third sensor configured to monitor a vibration acceleration of the knocking wheel 314, a fourth sensor configured to monitor a vibration acceleration of the supporting frame, a fifth sensor configured to monitor a vibration acceleration of a front wheel, a sixth sensor configured to monitor a vibration acceleration of a rear wheel, and a data collection module 401 configured to store collected response information.

In the present embodiment, the first sensor 201 uses a pressure sensor. The second sensor uses a sound pressure sensor. Both the third sensor and the fourth sensor use acceleration sensors.

Preferably, on the structure recorded in Embodiment 2, the first sensor 201 may be mounted at the knocked shaft 303, for example, fixed between a bottom end of the knocked shaft 303 and the upper wheel seat 312 by nuts.

Preferably, the second sensor is mounted beside the knocking wheel 314, the third sensor is mounted on the knocking wheel 314, and the fourth sensor is mounted on the supporting frame.

### Embodiment 4

A movable recognition method for a track structure disease, implemented on the basis of the movable apparatus in any of the above embodiments, includes the following steps:
the movable apparatus is placed on the recognized track, all electrical devices in the movable apparatus are powered on, and a required loading spacing is set according to an actual track spacing of the recognized track;
the knocking wheel 314 is arranged directly above a first detected track, and the loading assembly is started;
the movable apparatus is manually pushed to move forward on the recognized track; during a process of moving forward, a forward distance is monitored in real time by the mileage monitoring module 403; when the movable apparatus moves forward by a loading spacing, the hammering mechanism is driven by the control module 402 to operate once to complete one excitation loading on the recognized track;
obtained data such as a force, a vibration acceleration, and a sound pressure is collected by the data collection system in real time, transmitted to a background or a cloud wirelessly, and/or stored in a data collection module 401; and
when the movable apparatus reaches an endpoint of the current recognition task, the movable apparatus is stopped pushing, and power is turned off to shut down and/or local data stored in the data collection module 401 is exported for subsequent analysis.

The purposes, technical solutions, and beneficial effects of the present disclosure are further described in detail in the previously described specific implementations. It is to be understood that the previously described descriptions are only specific implementations of the present disclosure, but are not intended to limit the scope of protection of the present disclosure. Any modification, equivalent replacement, or improvement made within the spirit and principle of the present disclosure shall fall within the scope of protection of the present disclosure.

It is also to be noted that relational terms such as first and second are only used to distinguish one entity or operation from another entity or operation herein, and do not necessarily require or imply the existence of any such actual relationship or order between these entities or operations. Moreover, terms “include”, “contain” or any other variations thereof are intended to cover a non-exclusive inclusion, such that a process, method, article or device including a series of elements not only includes those elements, but also includes those elements that are not explicitly listed, or includes elements inherent to such a process, method, article or device. In addition, term “connected” used herein may be directly connected or indirectly connected through other components without special explanation.

1. A movable apparatus for track structure disease recognition, comprising a supporting frame, wherein the movable apparatus further comprises a loading assembly, a travelling assembly, and a control system that are connected to the supporting frame, as well as a data collection system configured to collect response information fed back from a recognized track,
the loading assembly comprises a knocking wheel (314) configured to roll on a top surface of the recognized track, and a hammering mechanism configured to apply an excitation load downwards to the knocking wheel (314);
the travelling assembly comprises travelling wheels (501) located at a front end and a rear end of the knocking wheel (314); the travelling wheels (501) are configured to roll on the top surface of the recognized track;
the control system comprises a mileage monitoring module (403) configured to monitor distance travelled by any of the travelling wheels (501), and a control module (402) configured to drive the hammering mechanism to operate; and the mileage monitoring module (403) is connected with the control module (402) through signals.

2. The movable apparatus for track structure disease recognition according to claim 1, wherein the hammering mechanism comprises a mounting plate (308) fixed to the supporting frame, a knocked shaft (303) penetrating through the mounting plate (308), a force transmission wheel (313) connected below the knocked shaft (303), a knocking hammer (302) located above the knocked shaft (303), and a power mechanism configured to drive the knocking hammer (302) to knock a top end of the knocked shaft (303); the power mechanism is connected to the mounting plate (308); and the force transmission wheel (313) is in contact with a top end of the knocking wheel (314).

3. The movable apparatus for track structure disease recognition according to claim 2, wherein the movable apparatus further comprises a lower wheel seat (310) configured to mount the knocking wheel (314), and a mounting seat (309) fixedly connected to both the knocked shaft (303) and the lower wheel seat (310), the mounting seat (309) is suspended below the mounting plate (308) through several connecting pieces (301); and a suspension height of the mounting seat (309) is adjustable.

4. The movable apparatus for track structure disease recognition according to claim 3, wherein the movable apparatus further comprises an upper wheel seat (312) configured to mount the force transmission wheel (313), and a first elastic piece (311) sleeved outside the knocked shaft (303), the upper wheel seat (312) is connected to a bottom end of the knocked shaft (303); and the first elastic piece (311) is located between the upper wheel seat (312) and the mounting seat (309).

5. The movable apparatus for track structure disease recognition according to claim 3, wherein the power mechanism comprises a cam (307), a motor (304) configured to drive the cam (307) to rotate, a rotating rod (315) movably pressed against the cam (307), and a fixing rod (316) in rotating fit with the rotating rod (315); the knocking hammer (302) is mounted on the rotating rod (315); the fixing rod (316) is fixedly connected to the mounting plate (308); and the motor (304) is connected with the control module through signals.

6. The movable apparatus for track structure disease recognition according to claim 5, wherein the movable apparatus further comprises a second elastic piece (317), and a positioning piece (318) located below the mounting plate (308), two ends of the second elastic piece (317) are respectively detachably connected to the rotating rod (315) and the positioning piece (318).

7. The movable apparatus for track structure disease recognition according to claim 5, wherein the movable apparatus further comprises a triggering plate (305) that is coaxially and fixedly connected to the cam (307), and a sensing device (306) that matches the triggering plate (305); the sensing device (306) is configured to sense a rotating direction of the triggering plate (305); and the sensing device (306) is connected to the control module (402) through signals.

8. The movable apparatus for track structure disease recognition according to claim 1, wherein the travelling assembly further comprises several auxiliary wheels (502) that are located at a bottom of the supporting frame and are inwards distributed in pairs, and several universal wheels (503) located below the supporting frame.

9. The movable apparatus for track structure disease recognition according to claim 1, wherein the control system further comprises a human-computer interaction module (202) connected to the control module through signals.

10. The movable apparatus for track structure disease recognition according to claim 1, wherein the data collection system comprises a first sensor (201) configured to monitor a hammering force of the hammering mechanism, a second sensor configured to monitor wheel-track noise of the knocking wheel (314) and the recognized track, a third sensor configured to monitor a vibration acceleration of the knocking wheel (314), a fourth sensor configured to monitor a vibration acceleration of the supporting frame, a fifth sensor configured to monitor a vibration acceleration of a front wheel, a sixth sensor configured to monitor a vibration acceleration of a rear wheel, and a data collection module (401) configured to store collected response information.

11. The movable apparatus for track structure disease recognition according to claim 2, wherein the travelling assembly further comprises several auxiliary wheels (502) that are located at a bottom of the supporting frame and are inwards distributed in pairs, and several universal wheels (503) located below the supporting frame.

12. The movable apparatus for track structure disease recognition according to claim 3, wherein the travelling assembly further comprises several auxiliary wheels (502) that are located at a bottom of the supporting frame and are inwards distributed in pairs, and several universal wheels (503) located below the supporting frame.

13. The movable apparatus for track structure disease recognition according to claim 4, wherein the travelling assembly further comprises several auxiliary wheels (502) that are located at a bottom of the supporting frame and are inwards distributed in pairs, and several universal wheels (503) located below the supporting frame.

14. The movable apparatus for track structure disease recognition according to claim 5, wherein the travelling assembly further comprises several auxiliary wheels (502) that are located at a bottom of the supporting frame and are inwards distributed in pairs, and several universal wheels (503) located below the supporting frame.

15. The movable apparatus for track structure disease recognition according to claim 2, wherein the control system further comprises a human-computer interaction module (202) connected to the control module through signals.

16. The movable apparatus for track structure disease recognition according to claim 3, wherein the control system further comprises a human-computer interaction module (202) connected to the control module through signals.

17. The movable apparatus for track structure disease recognition according to claim 4, wherein the control system further comprises a human-computer interaction module (202) connected to the control module through signals.

18. The movable apparatus for track structure disease recognition according to claim 2, wherein the data collection system comprises a first sensor (201) configured to monitor a hammering force of the hammering mechanism, a second sensor configured to monitor wheel-track noise of the knocking wheel (314) and the recognized track, a third sensor configured to monitor a vibration acceleration of the knocking wheel (314), a fourth sensor configured to monitor a vibration acceleration of the supporting frame, a fifth sensor configured to monitor a vibration acceleration of a front wheel, a sixth sensor configured to monitor a vibration acceleration of a rear wheel, and a data collection module (401) configured to store collected response information.

19. The movable apparatus for track structure disease recognition according to claim 3, wherein the data collection system comprises a first sensor (201) configured to monitor a hammering force of the hammering mechanism, a second sensor configured to monitor wheel-track noise of the knocking wheel (314) and the recognized track, a third sensor configured to monitor a vibration acceleration of the knocking wheel (314), a fourth sensor configured to monitor a vibration acceleration of the supporting frame, a fifth sensor configured to monitor a vibration acceleration of a front wheel, a sixth sensor configured to monitor a vibration acceleration of a rear wheel, and a data collection module (401) configured to store collected response information.

20. The movable apparatus for track structure disease recognition according to claim 4, wherein the data collection system comprises a first sensor (201) configured to monitor a hammering force of the hammering mechanism, a second sensor configured to monitor wheel-track noise of the knocking wheel (314) and the recognized track, a third sensor configured to monitor a vibration acceleration of the knocking wheel (314), a fourth sensor configured to monitor a vibration acceleration of the supporting frame, a fifth sensor configured to monitor a vibration acceleration of a front wheel, a sixth sensor configured to monitor a vibration acceleration of a rear wheel, and a data collection module (401) configured to store collected response information.
